(19) United States
(12) Patent Application Publication
(10) Pub. No.: US 2010/0091024 A1
(43) Pub. Date: Apr. 15, 2010

(54) METHOD AND DEVICE FOR GENERATING CUSTOM FONTS

(75) Inventor: Srikanth Myadam, Banglore (IN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/466,584

(22) Filed: May 15, 2009

(30) Foreign Application Priority Data
May 16, 2008 (GB) 0808988.0

(51) Int. Cl. G06T 11/00; G06K 15/02

(52) U.S. Cl. 345/471; 345/467; 358/1.11

(57) ABSTRACT

The invention provides a method and device for dynamically generating a textured font character. It enables any image to be selected and combined with a chosen character mask to produce a new font having the same content as the image.

### RELATED APPLICATIONS

This application was originally filed as and claims priority to Great Britain Patent Application No. 0808988.0 filed on 16 May 2009.

### TECHNICAL FIELD

The present application relates to a method for dynamically generating fonts. In particular but not exclusively it relates to enabling fonts to be generated from any of a number of available images and shapes.

### BACKGROUND

In the fields of computing devices and graphical displays, it is generally desirable to be able to produce distinctive, interesting and eye-catching graphics to increase the user appeal of devices or displays. Various techniques can produce text fonts that have interesting fill colours and patterns, which are sometimes referred to as textured fonts. In general, such fonts must be pre-defined, that is, defined by a skilled font creator, and then stored in a font file of a device for subsequent display or printing.

### SUMMARY

According to a first example of the present invention there is provided a method of dynamically generating and drawing a font character, the method comprising: receiving an instruction to draw the font character; taking as input: (i) a glyph mask defining the shape of the character; and (ii) an image defining the appearance of the character; combining the glyph mask and the image to produce a masked image defining the font character; and drawing the masked image to an output device.

The output device could be a display screen or a printer.

Prior to combining the glyph mask and the image, the image may be scaled or cropped to correspond to the size of the glyph mask (or vice versa).

The instruction could include an identifier of the glyph mask and an identifier of the image.

Combining the glyph mask and the image could include combining a bitmap defining the glyph mask and a bitmap defining the image. The resulting masked image could be a bitmap.

According to a second example of the invention there is provided apparatus comprising: a processor; and a memory including executable instructions; the memory and executable instructions configured to, in cooperation with the processor, cause the apparatus to perform at least the following: receive an instruction to draw a font character; take as input: (i) a glyph mask defining a shape of the character; and (ii) an image defining an appearance of the character; combine the glyph mask and the image to produce a masked image defining the font character; and draw the masked image to an output device.

According to a third example of the invention there is provided a computer program for performing the method defined above.

According to a fourth example of the invention there is provided a computer readable medium including instructions for performing the method defined above.

The instruction could be actively initiated by a user of the apparatus. Alternatively the instruction could be automatically initiated by an application running on the device.

The apparatus could store a number of pre-defined font characters, and the said font character is preferably not present on the device prior to the step of receiving an instruction.

The glyph mask could be derived from a pre-defined glyph stored on the device. Alternatively the glyph mask could itself be pre-defined and stored on the device. The said image defining the appearance of the character could be a pre-defined image stored on the device. The said image could be selected by a user of the device.

The apparatus could be a computing device, or it could be provided within a computing device.

### BRIEF DESCRIPTION OF THE DRAWINGS

The invention will now be described by way of example with reference to the accompanying drawings, in which:

FIG. 1 shows a mobile device in accordance with an example embodiment of the present invention, together with an illustration of its memory components;

FIG. 2 shows an outline of the structure of an exemplary operating system;

FIG. 3 is a system diagram showing various elements of the device of FIG. 1;

FIG. 4 is a flow chart according to an example embodiment of the invention;

FIG. 5 shows an example glyph mask for use in accordance with an example embodiment of the present invention;

FIG. 6 shows an image which is to be combined with the glyph mask of FIG. 4; and

### DETAILED DESCRIPTION OF THE DRAWINGS

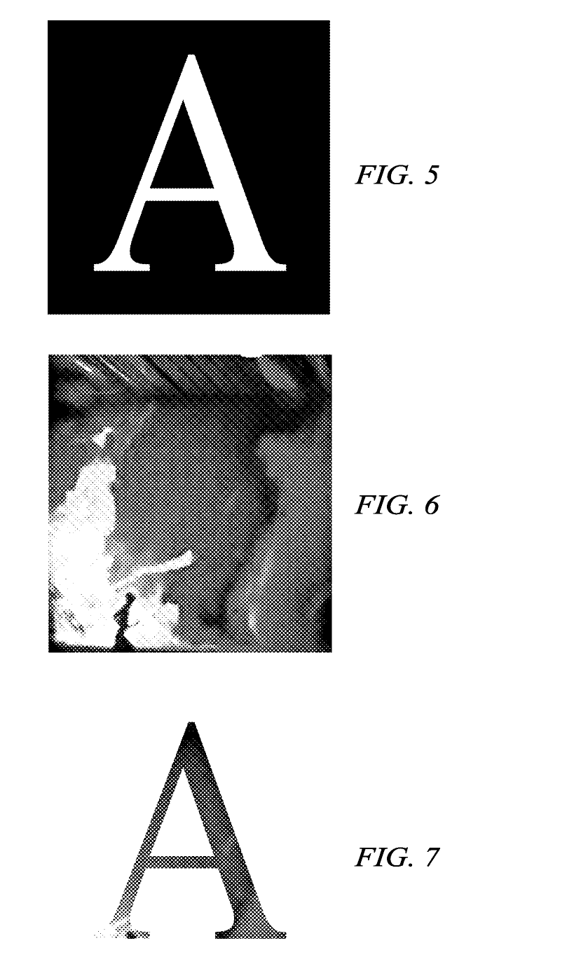

FIG. 7 shows a font character resulting from a combination of the glyph mask of FIG. 5 and the image of FIG. 6 in accordance with an example embodiment of the invention.

The following detailed explanation will focus on the example of a device running on the Symbian operating system (OS). It will be understood by the skilled person that the specific details provided in the context of this embodiment are given only with the intention of illustrating an example implementation of the invention and are not intended to limit its scope.

Symbian OS utilises a client-server architecture, whereby system resources are shared by server processes among multiple users (client processes), which may be system services or applications. It will be appreciated that this invention has applicability beyond client-server architectures, and that the details provided here are merely by way of example.

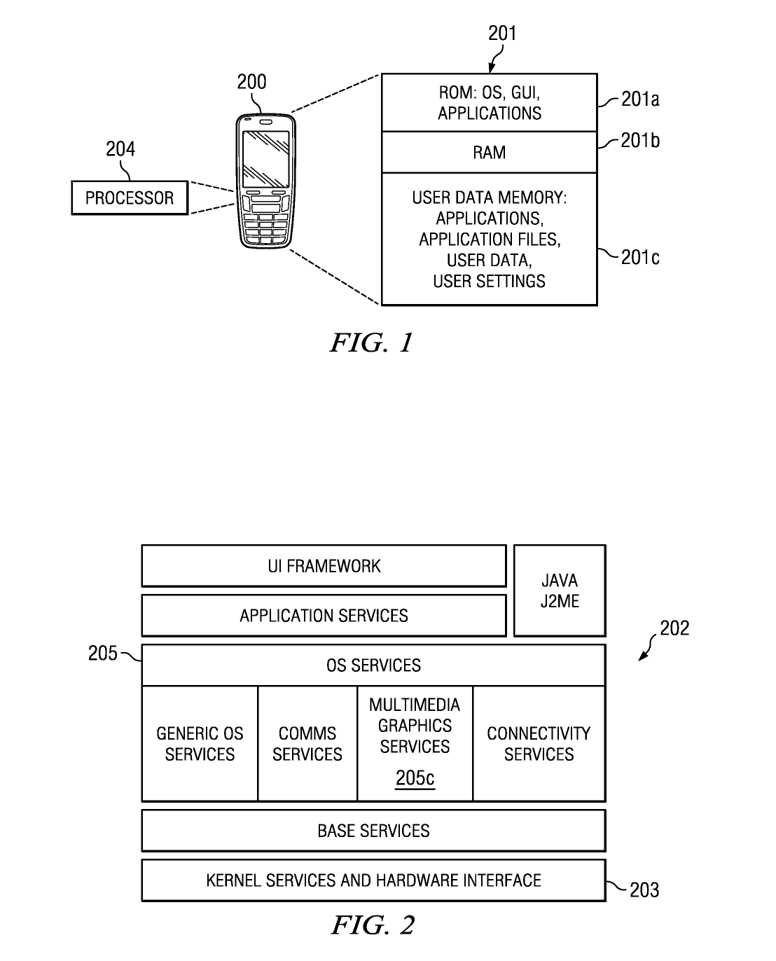

FIG. 1 shows a Symbian smartphone device 200, which represents an example of a device that could benefit from advantages of the invention. The device 200 has a processor 204, and various memory components 201: the ROM 201a holds system data and code such as the operating system (OS), the graphical user interface (GUI) and various applications; the RAM 201b is generally used for temporary storage of data and code that is to be passed to a processor of the device (not shown) for execution; and the user data memory 201c is provided for storage of a user's personal data files, downloaded applications and settings. In an example, the user data memory contains a series of photos taken by the user.

FIG. 2 shows an outline of the architecture of Symbian OS 202. It is illustrated in a layered format representing the relative abstraction from hardware of each part of the OS, with the greatest level of abstraction being at the top of the model. In the context of the description of this invention, the most interesting layer is the OS Services layer 205 which contains various blocks including Multimedia and Graphics Services 205c.

The Multimedia and Graphics Services block provides all graphics services above the level of hardware drivers. As can be seen from FIG. 2, the Multimedia and Graphics Services block lies above the kernel layer 203, and is therefore, from the kernel perspective, a user-side process; it runs in non-privileged mode and acts as a server to its own user-side clients, and as a client when communicating with the kernel.

The Multimedia and Graphics Services block includes a Graphics Device Interface (GDI), which provides an abstract interface to graphics device hardware on the smartphone. (The physical interface is handled by device drivers in the Kernel Services and Hardware Interface layer 203 shown in FIG. 2.) The Multimedia and Graphics Services block also includes a Bit GDI, which rasterises graphical data (i.e. converts it into pixels) and provides it to bitmap devices for display. From the perspective of the graphics system all graphics devices, such as built-in display screens, remote display devices, or printers, are bitmap devices—that is they require input data to be in bitmap format, i.e. represented as a pattern of bits each of which specifies the appearance (i.e. colour) of a pixel.

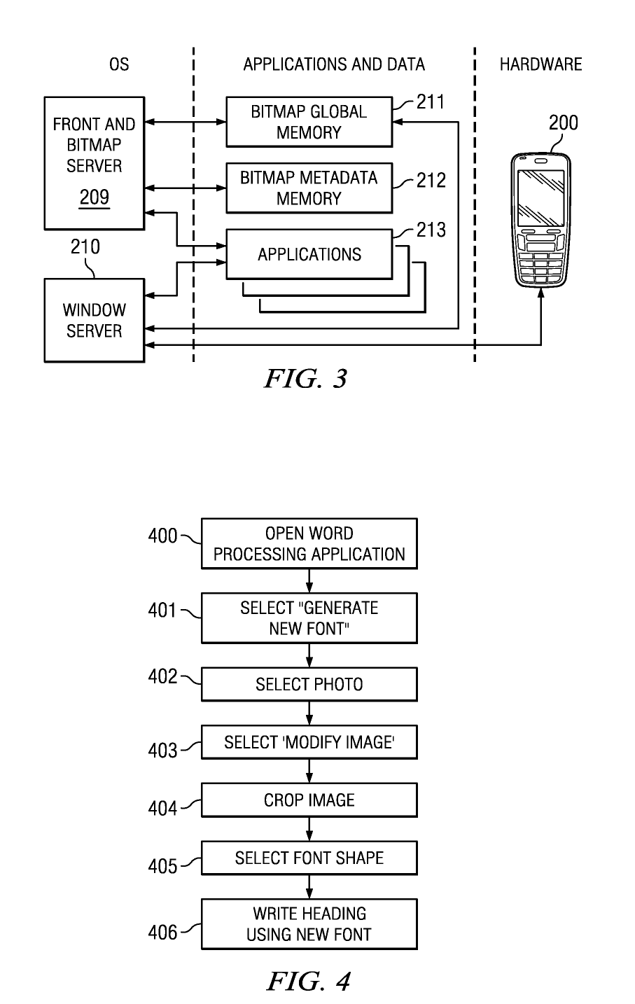

The Multimedia and Graphics Services block communicates with client processes through a number of servers including a Font and Bitmap Server 209 and a Window Server 210 as shown in FIG. 3.

In this example, the Window Server 210 controls the display screen of the device 200. It owns the screen as a resource, and uses the concept of application-owned windows to serialise access to the display by multiple concurrent applications.

The Font and Bitmap Server 209 owns the graphics devices and serialises client access to them. Access to the screen or to printers, including font operations, is conducted through a client session with the Font and Bitmap Server. This server ensures that screen operations are efficient by sharing single instances of fonts and bitmaps between its multiple clients. It also provides the framework for loading bitmap and vector fonts.

The Font and Bitmap Server delegates management of fonts to a Font Store process. The Font Store manages fonts in the system, including native Symbian OS format bitmapped fonts and open vector fonts. It provides APIs for storing, querying and retrieving bitmapped fonts, and properties of the fonts which may be stored as metadata. Vector fonts are drawn by a FreeType Font Rasteriser. On small-display devices such as smartphones, carefully optimised bitmap fonts can offer an improved font solution compared with standard vector fonts and so tend to be the preferred font format.

FIG. 3 illustrates the communications possible between various elements of the example smartphone 200. Applications 213 on the phone can communicate with the Window Server and Font and Bitmap Server in order to modify the device's display screen. Bitmap global memory 211 and bitmap metadata memory 212 are managed by the Font Store and can be accessed using the Font and Bitmap Server 209 when bitmap data is requested by a client process such as a user application process. The global memory contains bitmaps defining glyphs for different fonts. (A glyph is a shape of a symbol, a character, or a part of a character.) Bitmaps within the global memory may in general be accessed by any client process in the system, and may be accessed by means of a handle to the virtual memory address at which they are stored. The bitmap metadata memory includes properties of the bitmaps in the bitmap global memory, such as file size and font name. The global data and metadata could of course be stored within the same area of memory, and are only shown as separate items for clarity.

In an example embodiment, a user wishes to define a new custom font by blending a cropped image from a recent photo, with glyphs of a standard Ariel font type. She wishes to write the heading of a document using this new font.

Firstly, the user opens the application in which she intends to prepare the document. This is shown as block 400 in FIG. 4. The application in the example is a word processing application. It has been modified in this example embodiment of the invention, to provide a user with additional selectable options that enable the user to generate a new font. Thus, within the menu system displayed at the top of the running application, there is a selectable option labelled “Generate New Font”. When a user selects this menu option (401), a series of operations are undertaken within the application process; these are described below from the perspective of the user.

In this example embodiment, the application first launches a new window prompting the user to select a target image. She then browses through her photos folder to find the desired image of a fire, which she considers to have a high visual impact, and selects this in the application (402). The application then offers the user the option of modifying the image; the user selects this option (403). She then crops the image (404) to select a central portion of the image, leaving the flames of the fire visible in the lower left corner of the cropped image (FIG. 6). The user then proceeds to the next stage of the font generation process by selecting a font type from a number of pre-defined fonts, including the commonly available styles Ariel, Times New Roman, Courier, etc. The user selects Ariel (405). Having completed these operations the user is now able to write the heading of her document in her personalised font, selecting characters in the usual way by pressing the appropriate keys on a keyboard. It will be appreciated that the order of the operations described in the context of this example embodiment is merely illustrative and the invention is not limited to such an order.

Having regard now to details of the internal operation of the device, the application gains access to services provided by the Font and Bitmap Server, so that the application can access the pre-defined font glyphs stored by the Font Store and support the display of the generated font characters.

In this example embodiment, in response to the user's request to generate a new font, the application generates a client session with the Font and Bitmap Server. A new API, DrawText2( ) is provided by the Font and Bitmap Server to enable custom fonts to be created in accordance with the embodiment of the invention; this API is called by the application. DrawText2( )is a modified version of a conventional DrawText( )API that enables ordinary fonts to be drawn to an output device. DrawText2( )has enhanced functionality and enables the creation of new fonts. DrawText2( )calls a further API, BitBltMasked( ) The name of this API is abbreviated from “bit blit masked”, where the term “blitting” can be used to mean copying image data from a source to a destination, the destination commonly being a display screen. Unlike a standard blitting API, BitBltMasked( )operates by taking two images as arguments, and combining them before they are drawn to a destination. In this example embodiment, BitBltMasked( )takes as its arguments the photo image selected by the user and a glyph mask in the shape of a font character, discussed below. BitBltMasked( )blits these two items together onto the screen, such that the resulting image is a masked version of the photo image, shown in FIG. 7.

In the example, the bitmaps stored by the Font Store represent a solid pixel with a binary “1” and an empty pixel with a “0”. By drawing the regions represented by 1s and not drawing the regions represented by 0s, the desired font can be displayed on the screen. The term “draw” is used broadly, and can have meanings including preparing data for display on a screen, displaying data on a screen, or preparing data for printing.

In the example embodiment, once a character has been selected by means of a user's key press, the desired font bitmap is retrieved by the Font Store. An API provided by the Font Store is then called by the DrawText2( )API, in order to generate a mask from the retrieved bitmap. The API inverts the retrieved bitmap to produce an inverse bitmap, which represents “do not draw” as a “1” and “draw” as a “0”: a black-and-white graphical representation of the inverse bitmap is shown in FIG. 5.

It should be noted that the inverse bitmap could alternatively be produced by copying the bitmap data to memory and inverting the memory, then writing the inverted data to a bitmap. In a further alternative, an inverse bitmap could be pre-generated by drawing with an inverted pen when writing the data to bitmap, the pre-generated inverse bitmap then being stored on the device and managed by the Font Store in the usual way.

In the example embodiment the glyph mask (FIG. 5) can be used to convert a standard rectangular image into an image having the same shape as the glyph, as described in relation to BitBltMasked( )above. In an example embodiment a calculation is first performed to determine the size and shape of the glyph mask, measured in pixels. The size of the selected image, whose memory location is provided by the application, is then compared with the size of the glyph mask. In the example, a user has selected a photo from a user data folder and an appropriate server in the Multimedia and Graphics Services block is invoked to retrieve this image from its physical location. A further Font Store API is then called by DrawText2( )to scale the portion of the image selected by the user to fit within the rectangle defined by the glyph mask. The cropped, scaled image is shown in FIG. 6.

In this example the image data is stored as a colour bitmap and thus does not need to be rasterised; however depending on the original image type, pre-processing (e.g. converting from a vector graphics format) may be required before the scaling takes place.

Once the parameters of the custom font (i.e. the font type and the image) have been selected by the user, then each time a font character is to be drawn the application calls the DrawText2( )API provided by the Font and Bitmap Server causing the Font Store to retrieve a font bitmap corresponding to a desired character selected by a user. The desired font glyph, identified by a corresponding key press, is then combined with the previously selected image, and the resulting masked image is drawn to the screen. This process is repeated for each font character written by the user, until the user turns off the font generation option. It should be noted that in this example embodiment, the custom-generated font character is in the format of an image file, not a font, and so it cannot be stored and re-used by the Font Store in the same way as a regular font. Dynamic generation of each instance of the custom font is therefore appropriate.

The generation of the custom font in the example embodiment is dynamic, in the sense that it is performed on demand. This is in contrast to prior font generating techniques, where the font would be created in advance of the need for the font and pre-stored on the device ready for use.

Instead of a designer “colouring” or filling a blank font shape with a desired pattern, the font acquires its appearance by virtue of an image being masked using a font shape to create an image in the shape of the mask. Embodiments of the invention can thus provide significant freedom to device end users, application developers and user interface developers to customise the appearance of a font.

There are several disadvantages to known techniques for generating custom-designed fonts. Firstly, it can be time consuming to produce them. Every character that may be required—typically including lower case letters, upper case letters, italic versions, bold versions, numeric digits, punctuation marks and common symbols such as arrows—needs to be individually written by a font designer. Since this task requires a skilled designer, it is also costly. In addition, there is a requirement that every custom font that is available for use on a device must be stored on the device. In order to make a large number of fonts available to applications and users, valuable memory resources must be consumed by the corresponding font files. This is a particularly significant issue when mobile computing devices are considered, since resources are relatively more scarce than on desktop computers or large servers. Another limitation of prior font generation techniques is that a device user generally cannot create any textured font that he desires: he is limited to those that are already stored on his device and those that may be downloaded to his device. Similarly, user interface designers and application designers are limited to those fonts that have been pre-defined and are available to them. The possibilities for customising the appearance of a display are therefore limited.

It can be understood from the above description of example embodiments that some implementations of the invention may result in a user experiencing an increased delay before the new font characters appear on a screen, due to the processing required to generate the font characters. However it is not envisaged that this delay would be significant, and the advantages of the invention may outweigh the disadvantages of the processing overhead in many circumstances. As noted above, the visual appeal of text that can be obtained using embodiments of this invention is limited only by the type of images available to a developer or user; any textured font imaginable could be created dynamically using embodiments of the invention.

It will be apparent to the skilled person that many modifications may be made to the above-described example while remaining within the scope of the invention.

For example, it will be understood that the starting point for generating a font may not be a bitmap-format glyph and a bitmap-format image; data in any graphics format could equally be used, and rasterising may then be required prior to combining the mask glyph and the image. In some embodiments of the invention no changes would be required to standard rasterising techniques.

In example embodiments the image could optionally be dynamically downloaded from a remote server into memory, in time for the new textured font to be generated; the image need not reside on the device at the time when an application or user desires to create the new font character.

It can be envisaged that in some examples the display of dynamically-generated custom fonts could be built into an application, so that when a user starts an application the name of the application is presented in a new font; the application could select images at random from a folder of images stored as application data, and alter the font when the application is opened, or periodically while the application is running. The application could alternatively have a selection of pre-defined image data written into it, so that when the application is loaded by a computing device the images are loaded with it, in order that they can be subsequently retrieved from memory as required to generate a custom font. Alternatively, a user could be provided with an option to select an image from which the text for the header of an application could be generated when the application starts.

Embodiments of the invention could be provided as software, or as hardware, or as a combination of software and hardware.

It will be understood that many different applications can be conceived for using the concept of this invention; those indicated herein are only provided as examples.

1. A method of dynamically generating and drawing a font character, the method comprising:
receiving an instruction to draw the font character;
taking as input:
(i) a glyph mask defining the shape of the character; and
(ii) an image defining the appearance of the character;
combining the glyph mask and the image to produce a masked image defining the font character; and
drawing the masked image to an output device.

2. A method according to claim 1 further comprising, prior to combining the glyph mask and the image, scaling or cropping the image to correspond to the size of the glyph mask.

3. A method according to claim 1 wherein the instruction includes an identifier of the glyph mask and an identifier of the image.

4. A method according to claim 1 wherein combining the glyph mask and the image comprises combining a bitmap defining the glyph mask and a bitmap defining the image.

5. A method according to claim 1 wherein the masked image is a bitmap.

6. Apparatus comprising:
a processor; and
a memory including executable instructions;
the memory and executable instructions configured to, in cooperation with the processor, cause the apparatus to perform at least the following:
receive an instruction to draw a font character;
take as input:
(i) a glyph mask defining a shape of the character; and
(ii) an image defining an appearance of the character;
combine the glyph mask and the image to produce a masked image defining the font character; and
draw the masked image to an output device.

7. Apparatus according to claim 6 wherein the instruction includes an identifier of the glyph mask and the image.

8. Apparatus according to claim 6 wherein the instruction is actively initiated by a user of the apparatus.

9. Apparatus according to claim 6 wherein the instruction is automatically initiated by an application running on the apparatus.

10. Apparatus according to claim 6 having stored thereon a number of pre-defined font characters, wherein the said font character is not present on the apparatus prior to receiving the instruction.

11. Apparatus according to claim 10 wherein the glyph mask is derived from a pre-defined glyph stored on the apparatus.

12. Apparatus according to claim 10 wherein the glyph mask is pre-defined and stored on the apparatus.

13. Apparatus according to claim 6 wherein the image defining the appearance of the character is a pre-defined image stored on the apparatus.

14. Apparatus according to claim 13 wherein the image is selected by a user of the apparatus.

15. A computer program for performing the method of claim 1.

16. A computer readable medium including instructions for performing the method of claim 1.
